(19) United States
(12) Patent Application Publication
(10) Pub. No.: US 2013/0342554 A1
(43) Pub. Date: Dec. 26, 2013

(54) METHOD, SYSTEM AND ELECTRONIC DEVICE FOR ASSOCIATION BASED IDENTIFICATION

(71) Applicants: Wong Hoo Sim, Singapore (SG); Teck Chee Lee, Singapore (SG); Toh Onn Desmond Hll, Singapore (SG)

(72) Inventors: Wong Hoo Sim, Singapore (SG); Teck Chee Lee, Singapore (SG); Toh Onn Desmond Hll, Singapore (SG)

(73) Assignee: CREATIVE TECHNOLOGY LTD, Singapore (SG)

(21) Appl. No.: 14/003,785

(22) PCT Filed: Mar. 2, 2012
(86) PCT No.: PCT/SG12/00065

§ 371 Date: Sep. 6, 2013

(30) Foreign Application Priority Data
Mar. 7, 2011 (SG) 201101633.4

(51) Int. Cl. G06T 1/60

(52) U.S. Cl. CPC G06T 1/60
USPC 345/564

(57) ABSTRACT

A method for association based identification. The method includes providing at least one identifier and communicating identification information based on the at least one identifier. The method further includes receiving and processing identification information. Each of the at least one identifier can be associated with a color code. Identification information can be processed in a manner so as to produce association data. The association data can be associated with at least a characteristic data from a set of library data. The set of library data can correspond to a library of color codes and a characteristic data from the set of library data can correspond to a color code from the library of color codes. The association data is based upon to produce output signals. The output signals can be based on characteristic data associable with the association data.

### FIELD OF INVENTION

The present disclosure generally relates to graphic processing and graphic data display. More particularly, various embodiments of the disclosure relate to a system, an electronic device and a method suitable for association based identification for efficient graphic data display.

### BACKGROUND

Various advancements in technology have provided avenues for electronic based drawing and coloring thereof. Electronic based drawing and coloring thereof can be associated with graphic processing.

Typically, a user may operate an electronic device such as a computer, having a display and a software based application suitable for electronic based drawing, in a manner so as to produce an electronic drawing. The electronic display can be displayed at the display of the computer.

Additionally, the software based application can be further suitable for facilitating the coloring of the electronic drawing. In this regard, the software based application can be associated with an electronic coloring palette having a plurality of color options. A user may, based on the electronic coloring palette, select a color from the plurality of color options for coloring the electronic drawing.

In an exemplary scenario, after producing the electronic drawing, the user may wish to color the electronic drawing. Conventionally, the electronic coloring palette is conveniently displayed, at the display of the computer, together with the electronic drawing so as to facilitate user selection of a color from the plurality of color options for coloring the electronic drawing.

The electronic drawing and the electronic coloring palette can be associated with graphic data displayed at the display of the computer. Thus display, at the display of the computer, of the electronic drawing and the electronic coloring palette can be associated with graphic data display.

In this regard, conventional graphic processing and graphic data display techniques include the display of an electronic coloring palette for facilitating user selection of a color while the user is coloring the electronic drawing. However, a portion of the display of the computer is required for displaying the electronic coloring palette. Thus it is appreciable that display of the computer cannot be optimized for user view of the electronic drawing during coloring.

It is therefore desirable to provide a solution to address at least one of the foregoing problems of conventional graphic processing and graphic data display techniques.

### SUMMARY OF THE INVENTION

In accordance with a first aspect of the disclosure, a method for association based identification is provided. The method includes providing at least one identifier and communicating identification information based on the at least one identifier. The method further includes receiving and processing identification information.

With regard to providing at least one identifier, each of the at least one identifier can be associated with a color code.

With regard to receiving and processing identification information, identification information can be processed in a manner so as to produce association data. The association data can be associated with at least a characteristic data from a set of library data. The set of library data can correspond to a library of color codes and a characteristic data from the set of library data can correspond to a color code from the library of color codes.

The association data is based upon to produce output signals. The output signals can be based on characteristic data associable with the association data.

In accordance with a second aspect of the disclosure, an electronic device is provided. The electronic device can be associated with a set of library data having at least one characteristic data. The set of library data can correspond to a library of color codes and a characteristic data from the set of library data corresponding to a color code from the library of color codes.

The electronic device can be configured for signal communication with a transmit module. The transmit module can be associated with at least one identifier. Additionally, the transmit module can be configured for communicating identification information associable with the at least one identifier.

The electronic device includes an input portion and a processing portion. The input portion can be coupled to the processing portion.

The input portion can be configured for receiving and processing identification information communicated from the transmit module in a manner so as to produce input signals. Identification information can be associated with at least one color code and input signals can be communicated from the input portion.

The processing portion can be coupled to the input portion in a manner so as to receive input signals. The processing can be configured to process input signals in a manner so as to produce association data. The association data can be associated with at least a characteristic data from the set of library data.

Additionally, the processing portion can be further configured to produce output signals based on association data. The output signals can be based on characteristic data associable with the association data.

### BRIEF DESCRIPTION OF THE DRAWINGS

Embodiments of the disclosure are described hereinafter with reference to the following drawings, in which:

FIG. 1 shows a system which includes a transmit module and a receive module, according to an embodiment of the disclosure;

FIG. 2a and FIG. 2b show a first exemplary implementation of the system of FIG. 1, according to an embodiment of the disclosure;

FIG. 3a to FIG. 3c show, respectively, a first identification strategy, a second identification strategy, and a third identification strategy in association with the first exemplary implementation of FIG. 2a and FIG. 2b, according to an embodiment of the disclosure;

FIG. 4a shows a second exemplary implementation of the system of FIG. 1, according to an embodiment of the disclosure;

FIG. 4b shows a third exemplary implementation of the system of FIG. 1, according to an embodiment of the disclosure; and

FIG. 5 shows a flow diagram for a method which can be implemented in association with the system of FIG. 1, according to an embodiment of the disclosure.

### DETAILED DESCRIPTION

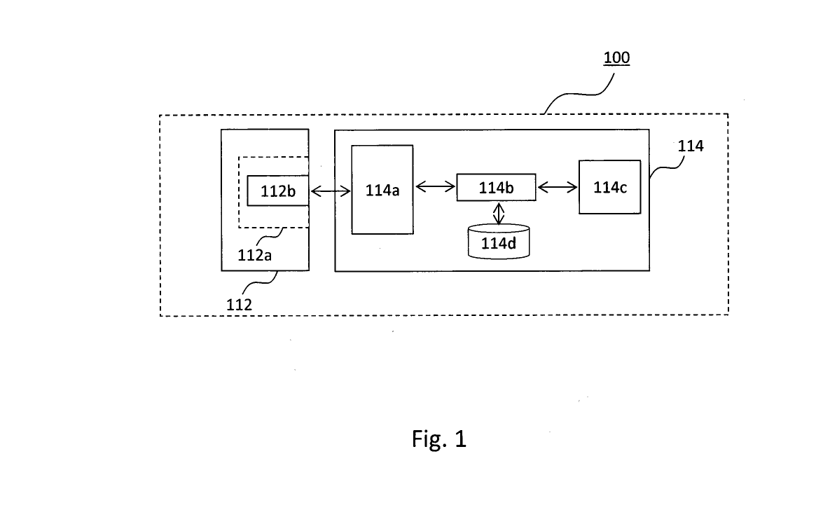

Representative embodiments of the disclosure for addressing one or more of the foregoing problems associated with conventional graphic processing and graphic data display techniques are described hereinafter with reference to FIG. 1 to FIG. 5.

A system 100 is shown in FIG. 1, in accordance with an embodiment of the disclosure. The system 100 can be configured for association based identification. The system 100 includes a transmit module 112 and a receive module 114. The transmit module 112 can be coupled to the receive module 114. The transmit module 112 can be coupled to the receive module 114 via one or both of wired coupling and wireless coupling. The transmit module 112 can be configured to signal communicate with the receive module 114.

The transmit module 112 includes a body portion 112a which can carry an identifier portion 112b. Based on the identifier portion 112b, identification information can be communicated from the transmit module 112 to the receive module 114.

The receive module 114 includes an input portion 114a and a processing portion 114b. The receive module 114 can further include a display portion 114c. The receive module 114 can yet further include a storage portion 114d. The input portion 114a can be coupled to the processing portion 114b. The processing portion 114b can be further coupled to the display portion 114c. The processing portion 114b can yet be further coupled to the storage portion 114d.

The input portion 114a can be configured to receive identification information communicated from the transmit module 112. The input portion 114a can be further configured to process received identification information in a manner so as to produce input signals. Input signals can be communicated from the input portion 114a to the processing portion 114b.

The processing portion 114b can be configured to receive and process input signals from the input portion 114a in a manner so as to produce association data. Based on the association data, the processing portion 114b can be further configured to produce output signals, as will be discussed later in further detail. Output signals can be communicated from the processing portion 114b to the display portion 114c.

The display portion 114c can be configured to receive and process output signals from the processing portion 114b in a manner so as to produce display data.

Earlier mentioned, the processing portion 114b can, based on association data, be configured to produce output signals.

In one embodiment, the processing portion 114b can include a database portion (not shown) which can be configured to store a set of library data. The set of library data can include one or more characteristic data. Each characteristic data can be associated with association data produced by the processing portion 114b. Specifically, association data produced by the processing portion 114b can be uniquely associated with a characteristic data from the set of library data.

In another embodiment, the storage portion 114d can be configured to carry the set of library data. As discussed earlier, the set of library data can include one or more characteristic data, each of which, can be associated with association data. In this regard, the foregoing pertaining to unique association of association data to a characteristic data analogously applies.

In yet another embodiment, a portion of the set of library data can be stored at the database portion of the processing portion 114b and another portion of the set of library data can be carried by the storage portion 114d. As discussed earlier, the set of library data can include one or more characteristic data, each of which, can be associated with association data. In this regard, the foregoing pertaining to unique association of association data to a characteristic data analogously applies.

Output signals from the processing portion 114b can be based on characteristic data uniquely associated with association data, as will be discussed in further detail hereinafter.

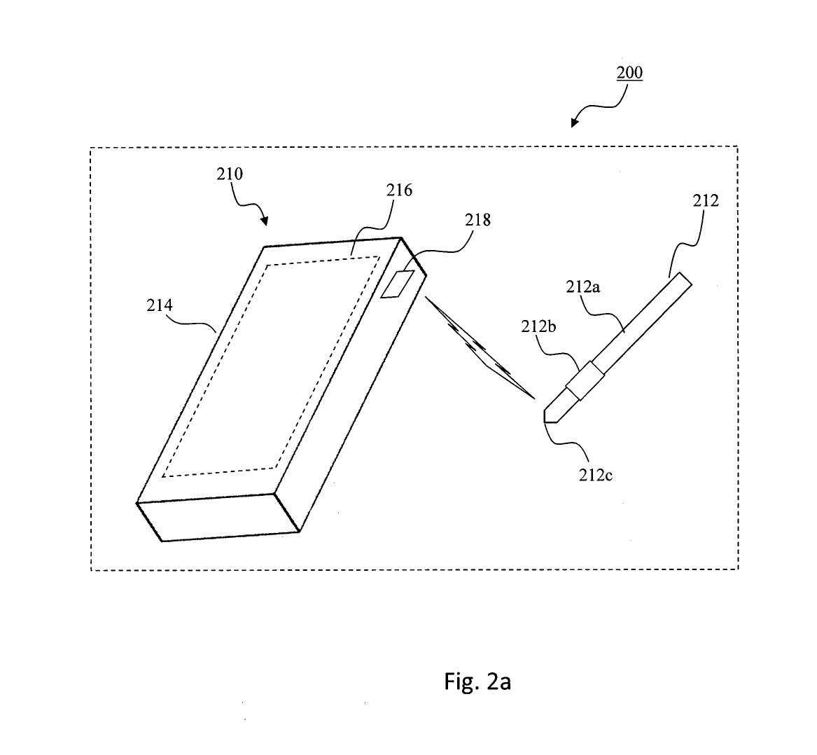

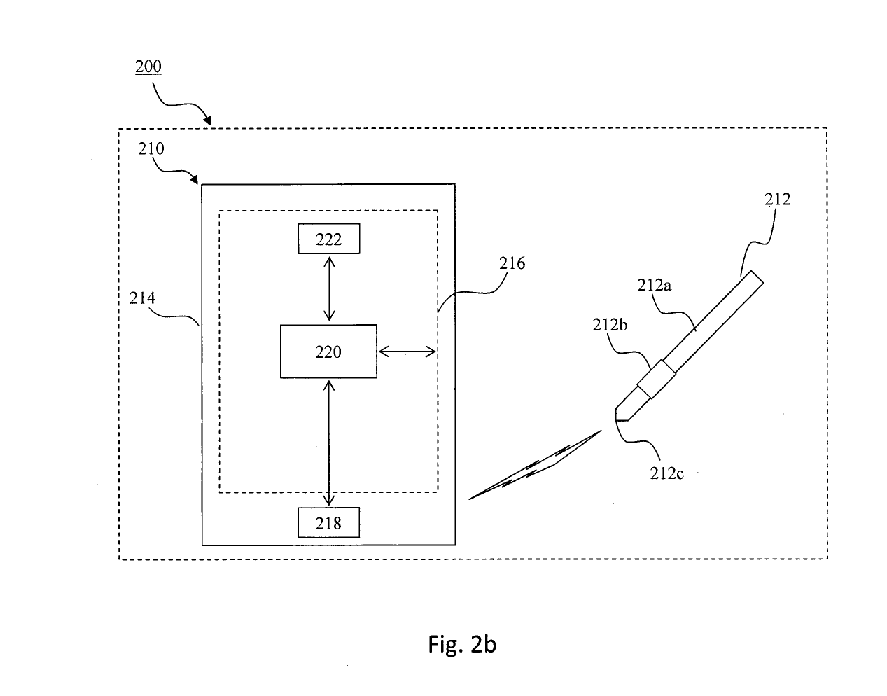

A first exemplary implementation 200 of the system 100 is shown in FIG. 2a and FIG. 2b, according to an embodiment of the disclosure. The first exemplary implementation 200 can be used in an exemplary application as will be discussed later in further detail.

The first exemplary implementation 200 can be associated with an electronic device such as an electronic tablet device 210 which can be configured for use with a stylus 212. The electronic tablet device 210 can be configured to signal communicate with the stylus 212.

Specifically, in the first exemplary implementation 200, the electronic tablet device 210 can, in conjunction with the stylus 212, be configured for use by a user. More specifically, a user can control the electronic tablet device 210 via the stylus 212. In this regard, a user can, using the stylus 212, generate control signals. Control signals can be communicated from the stylus 212 to the electronic tablet device 210.

The electronic tablet device 210 and the stylus 212 can correspond to the receive module 114 and the transmit module 112 respectfully. In this regard, control signals generated by the stylus 212, and communicated therefrom, can include the aforementioned identification information.

FIG. 2a shows an example of an outward appearance of the electronic tablet device 210. FIG. 2b shows the electronic tablet device 210 in further detail.

As shown in FIG. 2a, the electronic tablet device 210 can include a casing 214, a display screen 216 and a sensor 218. As shown in FIG. 2b, the electronic tablet device 210 can also include a processor 220. Additionally, the electronic tablet device 210 can optionally include a storage device 222.

Additionally, as shown in FIG. 2a and FIG. 2b, the stylus 212 can include a body part 212a carrying an identifier part 212b. The body part 212a and the identifier part 212b can correspond, respectively, to the body portion 112a and the identifier portion 112b of the transmit module 112. The stylus 212 can further include a tip 212c at one end of the body part 212a. The tip 212c can be coupled to the body part 212a. More specifically, the tip 212c can be one of detachably coupled to the body part 212a and permanently coupled to the body part 212a. The tip 212c can be of a material which is pliable so as to aid in the prevention of slipping when the tip 212c contacts and is moved about the display screen 216 of the electronic tablet device 210. Furthermore, the tip 212c can be of a suitable length so as to further aid in the prevention of slipping. Additionally, the tip 212c can be either a ballpoint based tip or a tapered edged based tip.

Referring to FIG. 2a, the casing 214 can be shaped and dimensioned to carry the display screen 216 in a manner so that the display screen 216 can be viewed by a user. Furthermore, the casing 214 can be shaped and dimensioned to carry the sensor 218 in a manner so that control signals communicated from the stylus 212 can be received by the sensor 218.

Referring to FIG. 2b, the casing 214 can be further shaped and dimensioned in a manner so as to carry the processor 220 and, optionally, the storage device 222 therein. The processor 220 can be coupled to the sensor 218. The processor 220 can also be coupled to the display screen 216. The processor 220 can be further coupled to the storage device 222.

The display screen 216, the sensor 218, the processor 220 and the storage device 222 correspond to the display portion 114c, the input portion 114a, the processing portion 114b and the storage portion 114d respectively. In this regard, the forgoing discussion pertaining to the input portion 114a, the processing portion 114b, the display portion 114c and the storage portion 114d analogously applies.

With regard to the stylus 212, the identifier part 212b of the stylus 212 can include one or more identifiers which can be associated with the aforementioned identification information. Each of the one or more identifiers can be associated with unique identification information. Thus identification information communicated from the stylus 212 can be based on at least an identifier from the one or more identifiers. For example, based on one identifier from the one or more identifiers, identification information corresponding to the identifier can be communicated to the electronic tablet device 210 via the sensor 218.

Based on the identification information received by the sensor 218, the sensor 218 can be configured to communicate input signals indicative of the identification information. The processor 220 can be configured to receive and process input signals communicated from the sensor 218.

Based on the input signals, the processor 220 can be configured to produce association data. Based on the association data, the processor 220 can be further configured to produce output signals which can be communicated to the display screen 216. The display screen 216 can be configured to receive and process output signals from the processor 220 in a manner so as to produce display data. Display data can, for example; correspond to graphic data viewable by a user of the electronic tablet device 210.

In one embodiment, the identifier part 212b of the stylus 212 can be a grip portion via which a user can hold the stylus 212.

In another embodiment, a portion of the body part 212a of the stylus 212 can be configured to carry the identifier part 212b whereas another portion of the body part 212a of the stylus 212 can be configured to carry a grip portion.

Preferably, the grip portion is configured such that a user can hold the stylus ergonomically. For example, the grip portion can be configured to afford a user better grip of the stylus 212 in a comfortable manner. The grip portion can, for example, be in a form of rubber-based tubing surrounding at least a portion of the stylus 212. The rubber-based tubing can be a padded resistive material. Thus a user can, by holding the stylus 212 via the grip portion, be afforded a better, yet comfortable, grip of the stylus 212.

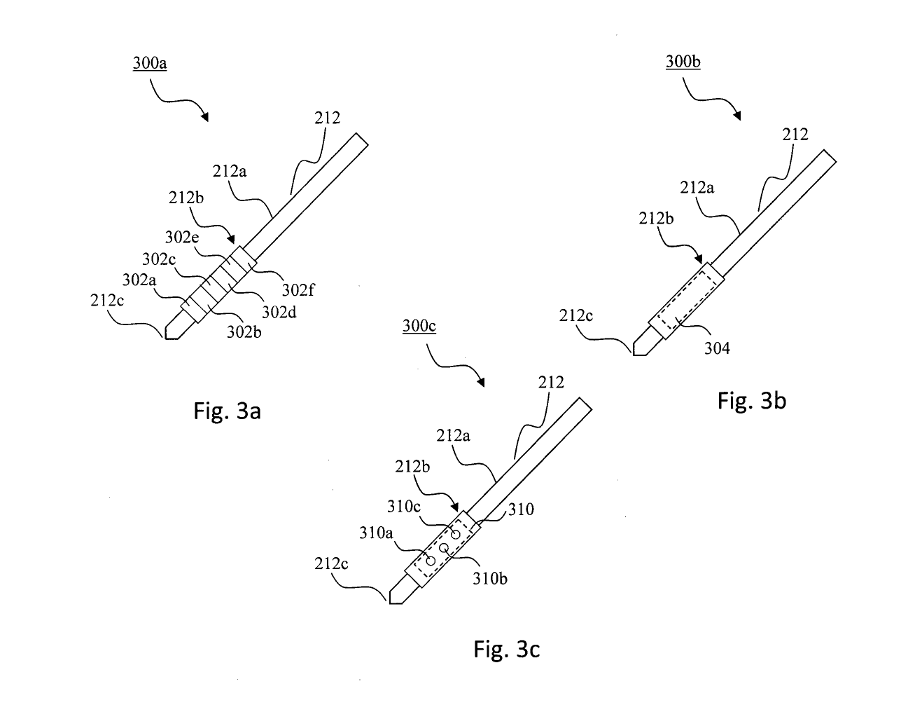

The stylus 212 can be configured to generate and communicate identification information via one or more identification strategies as will be discussed in further detail with reference to FIG. 3 hereinafter.

FIG. 3a to FIG. 3c show, respectively, a first identification strategy 300a, a second identification strategy 300b, and a third identification strategy 300c. The first identification, second identification and third identification strategies 300a/300b/300c can be associated with the first exemplary implementation 200.

Referring to FIG. 3a, the first identification strategy 300a is shown. In the first identification strategy 300a, the identifier part 212b of the stylus 212 can be associated with one or more identifiers. The one or more identifiers can be associated with corresponding one or more color codes. The identifier part 212b can be a grip portion which can, for example, include one or more color strips. Each of the one or more color strips can be associated with corresponding one or more color codes.

For example, the identifier part 212b can include a first color strip 302a, a second color strip 302b, a third color strip 302c, a fourth color strip 302d, a fifth color strip 302e and a sixth color strip 302f. In this regard, the identifier part 212b of the stylus 212 can be associated with a first to a sixth identifier corresponding, respectively, to the first to the sixth color strips 302a/302b/302c/302d/302e/302f. For example, the first to sixth color strips 302a/302b/302c/302d/302e/302f correspond, respectively, the color red, the color yellow, the color green, the color blue, the color orange, the color grey. In this regard, the aforementioned one or more color codes can, for example, correspond to the color red, the color yellow, the color green, the color blue, the color orange, the color grey.

Further in the first identification strategy 300a, the sensor 218 can be an image capturing device such as a camera. In this regard, the sensor 218 can be configured to communicate input signals indicative of color code of any of the first to the sixth color strips 302a/302b/302c/302d/302e/302f.

In one embodiment, the sensor 218 can be associated with a detection region (not shown). A user holding the stylus 212 can align at least one of the first to the sixth color strips 302a/302b/302c/302d/302e/302f to the detection region of the sensor 218 such that the sensor 218 can detect at least one color code. For example, a user holding the stylus 212 can align the first color strip 302a to the detection region of the sensor 218 such that the sensor 218 detects the color red. Thus identification information communicated from the stylus 212 can correspond to a color code such as the color red. The sensor 218 can communicate input signals indicative of the color code to the processor 220.

In another embodiment, the sensor 218 can be configured to emit a visible indicator (not shown). The visible indicator can be a light beam such as a laser beam. A user holding the stylus 212 can align at least one of the first to the sixth color strips 302a/302b/302c/302d/302e/302f to the visible indicator emitted by the sensor 218 such that the sensor 218 can detect at least one color code. For example, a user holding the stylus 212 can align the second color strip 302b to the visible indicator emitted by the sensor 218 such that the sensor 218 detects the color yellow. Appreciably, the visible indicator facilitates ease of alignment, by a user holding the stylus 212, for the purpose of detection, by the sensor 218, of a desired color strip from the first to the sixth color strips 302a/302b/302c/302d/302e/302f. Thus identification information communicated from the stylus 212 can correspond to a color code such as the color yellow. The sensor 218 can communicate input signals indicative of the color code to the processor 220.

In yet another embodiment, the sensor 218 can be configured to detect more than one color code. In this regard, a user holding the stylus 212 can, for example, align the stylus 212 such that a first color strip of the first to the sixth color strips 302a/302b/302c/302d/302e/302f can be detected by the sensor 218. Following the detection of the first color strip, the user can align the stylus 212 such that a second color strip of the first to the sixth color strips 302a/302b/302c/302d/302e/302f can be detected by the sensor 218. Thus the sensor 218 can be configured to detect a first color code, such as the color red, followed by a second color code, such as the color yellow.

Thus identification information communicated from the stylus 212 can correspond to a plurality of color codes which can include, for example, the color red and the color yellow. The sensor 218 can communicate input signals indicative of the plurality of color codes to the processor 220. For example, the sensor 218 can be configured to communicate a first set of input signals corresponding to the first color code and a second set of input signals corresponding to the second color code to the processor 220 for processing.

Based on the plurality of color codes, the processor 220 can be configured to produce association data indicative of a resultant color code based on the combination of the plurality of color codes. For example, where the first set and second set of input signals indicative, respectively, of the color red and the color yellow, are communicated to the processor 220, the processor 220 can be configured to produce association data indicative of the color orange.

In this regard, the processor 220 can be configured with a receipt delay so as to receive and process a sequence of input signals such as the first set and second set of input signals. The receipt delay can be associated with a predetermined time delay. For example, if the second set of input signals is received by the processor 220, after the first set of input signals, within the predetermined time delay, the processor 220 can be configured to process the first set and second set of input signals to produce association data indicative of the aforementioned resultant color code.

Otherwise, if the second set of input signals is received by the processor 220, after the first set of input signals, outside the predetermined time delay, the processor 220 can be configured to process the first set of input signals and the second set of input signals in a manner so as to produce a first association data indicative of the first color code and a second association data indicative of the second color code.

Although the first identification strategy 300a is discussed, as above, in the context of the identifier part 212b being the grip portion of the stylus 212, it is understood that it is not necessary for the identifier part 212b to be the grip portion of the stylus 212. More specifically, the body part 212a of the stylus 212 can carry a grip portion separate from the identifier part 212b.

Furthermore, in the first identification strategy 300a, the stylus 212 can, optionally, further include an indication portion (not shown) for white balancing. The indication portion for white balancing can be associated with color balance data. In this regard, control signals communicated from the stylus 212 can further include color balance data. Color balance data can thus be received by electronic tablet device 210 and processed by the processor 220 in a manner so as to, for example, adjust intensities of colors. In this manner, specific colors can be recognized and rendered more accurately.

Yet furthermore, in the first identification strategy 300a, the electronic tablet device 210 can be configured to detect motion associated with the stylus 212 via the sensor 218. Based on the motion detected, the processor 220 can be configured to further process at least one characteristic data from the set of library data in a manner so as to modify the characteristic data.

For example, characteristic data associated with association data can be modified based on detected motion associated with the stylus 212. Specifically, a user may move the stylus 212 in a certain manner. Movement of the stylus 212 can be detected as motion associated with the stylus 212. Thereafter, based on the detected motion, characteristic data such as a color code can be modified such that, for example, stroke thickness, brightness, hue, saturation, or any combination thereof, can be modified. The detected motion can, for example, be a gesture such as the stylus 212 being waved up and down by a user.

Referring to FIG. 3b, the second identification strategy 300b is shown. In the second identification strategy 300b, the identifier part 212b of the stylus 212 can be associated with one or more identifiers. The one or more identifiers can be associated with corresponding one or more graphic indications 304. The one or more graphic indications 304 can, for example, correspond to barcode-based indications, shape indications, pattern-based indications, numeric indications or alphabetic indications, or any combination thereof.

Barcode based indications can include two dimensional (2D) linear barcodes and three dimensional (3D) barcodes. In this regard, the sensor 218 can, for example, be a barcode scanner which is configured to read barcode based indications. Based on the barcode based indications, the sensor 218 can generate input signals. A 2D barcode or a 3D barcode can, for example, be indicative of one or more color codes.

Shape indications can include one or more regular shapes or irregular shapes. Regular shapes can include shapes such as square, circle and triangle. A regular shape or an irregular shape can, for example, be indicative of one or more color codes. For example, a square can be indicative of the color red. In this regard, the sensor 218 can be an image capturing device such as a camera. Thus the foregoing pertaining to the sensor 218 being an image capturing device as discussed in the first identification strategy 300a analogously applies.

Pattern-based indications can further include a sequence of markings which can be indicative of one or more color codes. In this regard, the sensor 218 can be an image capturing device such as a camera. Thus the foregoing pertaining to the sensor 218 being an image capturing device as discussed in the first identification strategy 300a analogously applies.

Numeric indications can include one or more numbers. Alphabetic indications can include one or more alphabets. A number or an alphabet can be indicative of one or more color codes. Thus, as with shape indications and pattern-based indications, the sensor 218 can be an image capturing device such as a camera. In this regard, the foregoing pertaining to the sensor 218 being an image capturing device analogously applies.

As mentioned above, the identifier part 212b can be a grip portion of the stylus 212. It is also appreciable that the body part 212a of the stylus 212 can also carry a grip portion separate from the identifier part 212b.

Furthermore, in the second identification strategy 300b, as with the first identification strategy 300a, the stylus 212 can, optionally, further include the earlier discussed indication portion for white balancing. In this regard, the earlier discussion pertaining to the indication portion for white balancing analogously applies.

Yet furthermore, in the second identification strategy 300b, as with the first identification strategy 300a, the electronic tablet device 210 can be configured to detect motion associated with the stylus 212 via the sensor 218. Based on the motion detected, the processor 220 can be configured to further process at least one characteristic data from the set of library data in a manner so as to modify the characteristic data. In this regard, the foregoing pertaining to the first identification strategy 300a analogously applies.

Referring to FIG. 3c, the third identification strategy 300c is shown. In the third identification strategy 300c, the identifier part 212b of the stylus 212 can be associated with one or more identifiers. The one or more identifiers can be associated with corresponding one or more data signals. Each of the one or more data signals can, for example, be Radio Frequency Identification (RFID) based data signals, Near Field Communication (NFC) based data signals, Bluetooth based data signals, Infra-red (IR) based data signals and Radio Frequency (RF) based data signals. Each of the one or more data signals can be associated with a signal frequency. The signal frequency can be indicative of one or more color codes.

In this regard, the stylus 212 can include a signal source (not shown) which can be configured to provide one or more data signals. The stylus 212 can further include one or more regions 310 for user activation. Each of the one or more regions 310 can be associated with a data signal. Thus, for example, by user activation of a region of the one or more regions 310, a corresponding data signal can be communicated from the stylus 212.

In one embodiment, the one or more regions 310 can correspond to one or more buttons which can be user activated by pressing. The one or more buttons can include a first button 310a, a second button 310b and a third button 310c. The first button 310a can be associated with a first data signal associated with a first frequency. The second button 310b can be associated with a second data signal associated with a second frequency. The third button 310c can be associated with a third data signal associated with a third frequency. The first, second and third frequencies can each be indicative of a color code. For example, the first, second and third frequencies can be indicative, respectively, of the color red, the color yellow and the color green.

In one example, via user activation of, for example, the first button 310a, the first data signal can be communicated from the stylus 212. Thus the first data signal which is indicative of the color red can be communicated from the stylus 212.

In another example, via user activation of more than one button, a composite data signal having a signal frequency based on the data signal of each button activated can be communicated from the stylus 212. For example, via user activation of the first and second buttons 310a/310b, a composite signal based on the first and second data signals can be communicated from the stylus 212. Thus the composite signal can have a signal frequency based on the first and second frequencies. The composite signal can be indicative of a color code which is based on the color codes associated with the first and second data signals. For example, where the first and second data signals are indicative of the color red and the color yellow respectively, the composite signal can be indicative of the color orange.

As mentioned above, the identifier part 212b can be a grip portion of the stylus 212. It is also appreciable that the body part 212a of the stylus 212 can also carry a grip portion separate from the identifier part 212b.

Furthermore, in the third identification strategy 300c, as with the first identification strategy 300a, the stylus 212 can, optionally, further include the earlier discussed indication portion for white-balancing. In this regard, the earlier discussion pertaining to the indication portion for white-balancing analogously applies.

Yet furthermore, in the third identification strategy 300c, as with the first identification strategy 300a, the electronic tablet device 210 can be configured to detect motion associated with the stylus 212 via the sensor 218. Based on the motion detected, the processor 220 can be configured to further process at least one characteristic data from the set of library data in a manner so as to modify the characteristic data. In this regard, the foregoing pertaining to the first identification strategy 300a analogously applies.

Although the stylus 212 can be configured to generate and communicate identification information via the first to third identification strategies 300a/300b/300c as discussed above, it is appreciable that other identification strategies are also useful.

For example, thickness of the stylus 212 and shape of cross-section of the stylus 212 (e.g. round, hexagon, triangle) can also be used for communication of identification information.

The first exemplary implementation 200 can be used in an exemplary application as will be discussed hereinafter.

In the exemplary application, a user of the tablet device 210 may use a general graphic based software application for the purposes of drawing and coloring a picture. The graphic based software application may include a library of color codes from which a color can be selected. The user may, via the stylus 212, communicate control signals in a manner so as to draw the picture. After the picture has been drawn, the user may wish to color the picture with a color code from the library of color codes. The picture can correspond to graphic data displayed at the display screen 216.

Earlier mentioned, based on the one or more identifiers associated with the stylus 212, identification information can be communicated from the stylus 212. Identification information can be received by the sensor 218. Based on the identification information received by the sensor 218, the sensor 218 can be configured to communicate input signals indicative of the identification information. The processor 220 can be configured to receive and process input signals communicated from the sensor 218.

Further earlier mentioned, based on the input signals, the processor 220 can be configured to produce association data. Yet further earlier mentioned a characteristic data of the set of library data can be associated with the association data. In this regard, the set of library data can correspond to the aforementioned library of color codes and the characteristic data can correspond to a color code from the library of color codes.

For example, the user may wish to color the picture with a color code corresponding to the color red. Identification information indicative of the color red can be communicated from the stylus 212 via any of the aforementioned first, second and third identification strategies 300a/300b/300c, or any combination thereof. Thus input signals communicated to the processor 220 can be indicative of identification information which can be based on the color red. Therefore the association data produced by the processor 220 can be uniquely associated with a characteristic data, from the set of library data, corresponding to the color red. Thus association of a characteristic data with the association data can correspond to association based identification.

As mentioned earlier, based on the association data, the processor 220 can be further configured to produce output signals which can be communicated to the display screen 216. The display screen 216 can be configured to receive and process output signals from the processor 220 in a manner so as to produce display data. Further earlier mentioned, output signals from the processing portion 114b can be based on characteristic data uniquely associated with association data. Hence, display data can be associated with, for example, a characteristic data which corresponds to the color red. In this regard, in addition to the picture displayed at the display screen 216, display data can further correspond to graphic data corresponding to the color red as the user colors the picture drawn.

Earlier mentioned, conventional graphic processing and graphic data display techniques include the display of an electronic coloring palette for facilitating user selection of a color. A portion of the display of the computer is required for displaying the electronic coloring palette. Thus display of the computer cannot be optimized for user view of the electronic drawing during coloring.

In this regard, based on the above discussion pertaining to the exemplary application_{;} it is appreciable that with regard to the system 100, it is not necessary to display the library of color codes, which can be analogous to the electronic coloring palette, at the display screen 216, since identification information indicative of a color code from the library of color codes can be communicated via any of the aforementioned first, second and third identification strategies 300a/300b/300c, or any combination thereof. Thus the display screen 216 can be optimized for user view for the purpose of viewing a picture during its coloring. In this manner, via association based identification, an avenue for efficient graphic data display can be afforded.

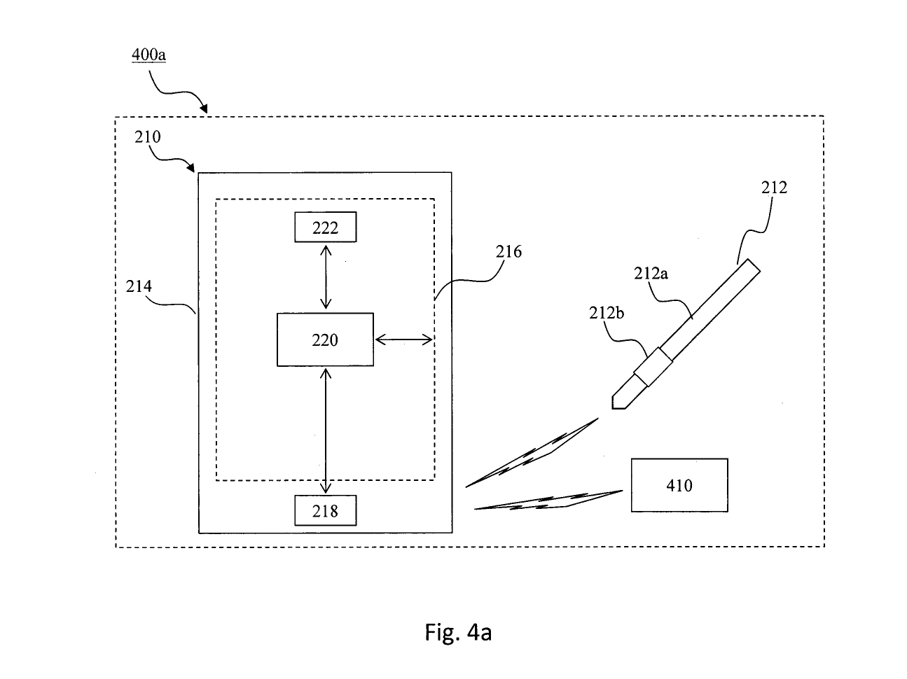

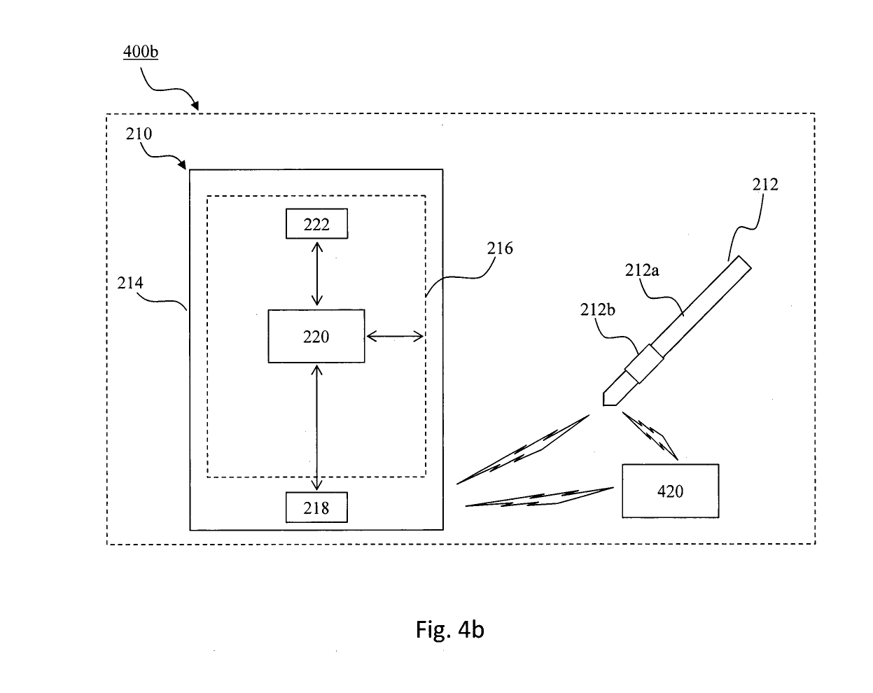

Referring to FIG. 4a, a second exemplary implementation 400a of the system 100 is shown, according to an embodiment of the disclosure. The second exemplary implementation 400a can, in addition to the aforementioned electronic tablet device 210 which can be configured for use with the stylus 212, be further associated with an identifier apparatus 410.

The identifier apparatus 410 can be configured to communicate identification information. In this regard, the foregoing pertaining to the electronic tablet device 210 analogously applies. Furthermore, although the electronic tablet device 210 can be configured for use with the stylus 212, it is appreciable that the stylus 212 can be omitted. Yet furthermore, where the stylus 212 is included, since identification information can be communicated from the identifier apparatus 410, inclusion of the identifier part 212b at the stylus 212 can be optional.

In general, the identifier apparatus 410 can be associated with one or more identifiers. The one or more identifiers can be associated with corresponding one or more color codes.

In one embodiment, the identifier apparatus 410 can include one or more color strips. Each of the one or more color strips can be associated with corresponding one or more color codes. In this regard, the foregoing pertaining to the first identification strategy 300a analogously applies.

In another embodiment, the identifier apparatus 410 can include one or more graphic indications. In this regard, the foregoing pertaining to the second identification strategy 300b analogously applies.

In yet another embodiment, the identifier apparatus 410 can be associated with one or more identifiers associated with corresponding one or more data signals. In this regard, the foregoing pertaining to the third identification strategy 300c analogously applies.

Referring to FIG. 4b, a third exemplary implementation 400b of the system 100 is shown, according to an embodiment of the disclosure. In the third exemplary implementation 400b, one or both of the aforementioned electronic tablet device 210 and the stylus 212 can be configured to receive identification information from the environment 420.

The environment 420 can, for example, be a tabletop, a wall, floor, carpet, an object or any surface within a room. In this regard, identification information from the environment 420 can be associated with graphic image associated with the, for example, tabletop. The tabletop can, for example, be associated with color arrangements, patterns or the combination thereof. Such color arrangements, patterns or the combination thereof, can generally be termed as texture associated with the environment 420.

Texture associated with the environment 420 can be either stochastic texture based or structured texture based.

In one example, where the electronic tablet device 210 is configured to receive, via the sensor 218, identification information from the environment 420, the processor 220 can be configured to process the received identification information via texture synthesis in a manner such that output signals communicated to the display screen 216 can correspond to the texture associated with the environment 420. In this regard, although the electronic tablet device 210 can be configured for use with the stylus 212, it is appreciable that the stylus 212 can be omitted. Furthermore, where the stylus 212 is included, since identification information can be communicated from the environment 420, inclusion of the identifier part 212b at the stylus 212 can be optional.

In another example, the stylus 212 can be configured to receive identification information from the environment 420. In this regard, the stylus 212 can further include a detector (not shown) for detecting and receiving identification information from the environment 420. The detector can be analogous to the sensor 218. In this regard, the foregoing pertaining to the sensor 218 analogously applies. After detecting and receiving identification information, the stylus 212 can be configured to communicate control signals corresponding to the identification information to the electronic tablet device 210. The electronic tablet device 210 can be configured to receive, via the sensor 218, control signals from the stylus 212. The processor 220 can be configured to process the received control signals via texture synthesis in a manner such that output signals communicated to the display screen 216 can correspond to the texture associated with the environment 420.

In yet another example, both the stylus 212 and the electronic tablet device 210 can be configured to receive identification information from the environment 420. In this regard, the foregoing pertaining to each of the electronic tablet device 210 and the stylus 212 receiving identification information from the environment 420 analogously applies. Furthermore, the foregoing pertaining to processing via texture synthesis, at the electronic tablet device 210, analogously applies.

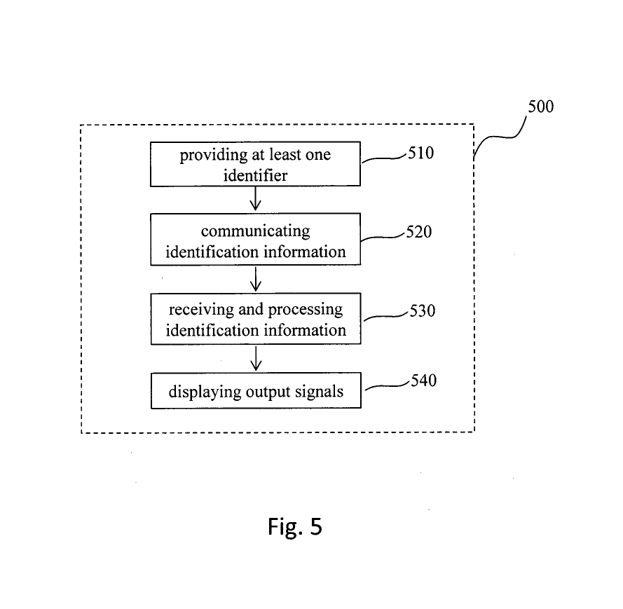

A method 500, which can be implemented in association with the system 100, is shown in FIG. 5. The method 500 can be suitable for association based identification.

The method 500 includes providing at least one identifier 510. At least one identifier can be provided at the transmit module 112.

The method 500 also includes communicating identification information 520. Identification information can be communicated from the transmit module 112. Identification information can be based on the at least one identifier.

The method 500 further includes receiving and processing identification information 530. Identification information can be received and processed at the receive module 114. Identification information can be received and processed at the receive module 114 in a manner so as to produce association data. Association data can be further processed in a manner so as to produce output signals. Specifically, identification information can be received at the input portion 114a and processed in a manner so as to produce input signals. Input signals can be communicated to the processing portion 114b for further processing in a manner so as to produce association data. Based on the association data, the processing portion 114b can be further configured to produce output signals.

The method 500 can yet further include displaying output signals 540. Output signals can be communicated from the processing portion 114b to the display portion 114c. The display portion 114c can be configured to receive and process output signals from the processing portion 114b in a manner so as to produce display data.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. A method for association based identification, the method comprising:
providing at least one identifier, each of the at least one identifier being associable with a color code;
communicating identification information based on the at least one identifier; and
receiving and processing identification information, identification information being processed in a manner so as to produce association data, the association data being associable with at least a characteristic data from a set of library data, the set of library data corresponding to a library of color codes and a characteristic data from the set of library data corresponding to a color code from the library of color codes,
wherein the association data is based upon to produce output signals, the output signals being based on characteristic data associable with the association data.

2. The method as in claim 1,
wherein a transmit module is provided for providing at least one identifier, the transmit module comprising an identifier portion carrying the at least one identifier, identification information being communicable from the transmit module, and
wherein a receiver module is provided for receiving and processing identification information communicated from the transmit module.

3. The method as in claim 2, wherein the receiver module comprises:
an input portion for receiving identification information communicated from the transmit module, the input portion being configurable for processing received identification information in a manner so as to produce input signals, input signals being communicable from the input portion; and
a processing portion coupled to the input portion, the processing portion being configurable for receiving and processing input signals from the input portion in a manner so as to produce association data.

4. The method as in claim 3, the processing portion comprising a database module for carrying the set of library data.

5. The method as in claim 3, wherein the receiver module further comprises a storage module for storing the set of library data.

6. The method as in claim 2, wherein the identifier portion being associable with a plurality of identifiers.

7. The method as in claim 6, wherein the plurality of identifiers correspond to a plurality of color strips, each of the plurality of color strips being associable with a color code.

8. The method as in claim 6, wherein the plurality of identifiers correspond to a plurality of graphic indications.

9. The method as in claim 8, wherein the plurality of identifiers correspond to at least one of barcode based indications, shape indications, pattern-based indications, numeric indications and alphabetic indications.

10. The method as in claim 8, wherein each of the plurality of graphic indications correspond to a color code.

11. The method as in claim 6,
wherein the plurality of identifiers correspond to a plurality of data signals, and
wherein each of the plurality of data signals correspond to a color code.

12. An electronic device associable with a set of library data having at least one characteristic data, the set of library data corresponding to a library of color codes and a characteristic data from the set of library data corresponding to a color code from the library of color codes, the electronic device being configurable for signal communicating with a transmit module associable with at least one identifier, the transmit module being configurable for communicating identification information associable with the at least one identifier, the electronic device comprising:
an input portion for receiving and processing identification information communicated from the transmit module in a manner so as to produce input signals, identification information being associable with at least one color code and input signals being communicable from the input portion;
a processing portion coupled to the input portion in a manner so as to receive input signals; the processing being configurable to process input signals in a manner so as to produce association data, the association data being associable with at least a characteristic data from the set of library data.

13. The electronic device as in claim 12, wherein the processing portion is further configurable to produce output signals based on association data, the output signals being based on characteristic data associable with the association data.

14. The electronic device as in claim 12,
wherein the electronic device is an electronic tablet device and
wherein the transmit module is one of a stylus and an identifier apparatus,

15. The electronic device as in claim 14,
wherein the stylus comprises a body part carrying an identifier part, the identifier part being associable with a plurality of identifiers, and
wherein the identifier apparatus is associable with a plurality of identifiers.

16. The electronic device as in claim 15, wherein the plurality of identifiers associable with one of the identifier part and the identifier apparatus correspond to a plurality of color strips, each of the plurality of color strips being associable with a color code.

17. The electronic device as in claim 15,
wherein the plurality of identifiers associable with one of the identifier part and the identifier apparatus correspond to a plurality of graphic indications, and
wherein each of the plurality of graphic indications correspond to a color code.

18. The electronic device as in claim 17, wherein the plurality of identifiers correspond to at least one of barcode based indications, shape indications, pattern-based indications, numeric indications and alphabetic indications.

19. The electronic device as in claim 15,
wherein the plurality of identifiers associable with one of the identifier part and the identifier apparatus correspond to a plurality of data signals, and
wherein each of the plurality of data signals correspond to a color code.

20. An electronic device associable with a set of library data having at least one characteristic data, the set of library data corresponding to a library of color codes and a characteristic data from the set of library data corresponding to a color code from the library of color codes, the electronic device being configurable for signal communicating with a transmit module associable with at least one identifier, the transmit module being configurable for communicating identification information associable with the at least one identifier, the electronic device comprising:
an input portion for receiving and processing identification information communicated from the transmit module in a manner so as to produce input signals, identification information being associable with at least one color code and input signals being communicable from the input portion;
a processing portion coupled to the input portion in a manner so as to receive input signals, the processing being configurable to process input signals in a manner so as to produce association data, the association data being associable with at least a characteristic data from the set of library data,
wherein the processing portion is further configurable to produce output signals based on association data, the output signals being based on characteristic data associable with the association data.
